(19) United States
(12) Patent Application Publication
(10) Pub. No.: US 2023/0217980 A1
(43) Pub. Date: Jul. 13, 2023

(54) PERSONALIZATION OF DIETARY AND NUTRACEUTICAL SUPPLEMENTS

(71) Applicant: DSM IP Assets B.V., Heerlen (NL)

(72) Inventors: Alan CONNOLLY, Kaiseraugst (CH); Nathan MATUSHESKI, Columbia, MD (US)

(21) Appl. No.: 18/010,827

(22) PCT Filed: Jun. 28, 2021
(86) PCT No.: PCT/EP2021/067674

§ 371 Date: Dec. 16, 2022

(30) Foreign Application Priority Data
Jun. 30, 2020 (EP) 20183048.6

(51) Int. Cl. A23L 33/15; A23L 33/155

(52) U.S. Cl. CPC A23L 33/15; A23L 33/155

(57) ABSTRACT

The present invention relates to edible particles of a first and a second variety. Particles of the two varieties share at least one common active ingredient. Preferred active ingredients are micro- and macronutrients. Personalization of dietary supplements is achieved by adapting the amount of the second variety to the individual needs of a consumer whereas the amount of the first variety may be the same for many consumers. Such an approach reduces manufacturing cost, increases compliance and gives maximum versatility to achieve true personalization.

### TECHNICAL FIELD

The present invention relates to the manufacturing of personalized dietary and nutraceutical supplements.

### BACKGROUND OF THE INVENTION

For decades, the principles of “economies of scale” has prevailed in the dietary and nutraceutical supplements market. Once a reasonable recipe had been determined, the selected supplement was being sold to millions of consumers. Only one kind of supplement had to be manufactured. Therefore, cost was low and profits were high. In the meantime, things have changed. It has been realized that the “one-fits-all” approach has its limitation. Nowadays, it is recommended to tailor supplements to the unique needs of each individual. Research-backed supplements are then delivered e.g. by postal service to the home of individuals.

Individual nutritional needs to vary depending upon age, gender, life stage, medical history, dietary behaviors and preferences. In addition, recommended nutrient intakes may also vary by country as different regulatory authorities often recommend different target nutrient levels for promotion of public health. Varying recommendations from country-to-country present a technical barrier to manufacturing personalized nutritional foods and supplements.

Manufacturing personalized mixes of micronutrients increases cost tremendously. By definition, economy of scale does no longer apply when producing personalized quantities of dietary and nutraceutical supplements. This is the reason why truly personalized solutions are still very rare. In many cases, companies offer only a limited number of recipes, e.g. one for men, another for women and a third one for elderly people. Splitting a population of millions into three groups is anything but true personalization—even if the men's mix is labelled with the name of the customer.

There is a need for efficiently manufacturing personalized mixes of active ingredients. To keep cost low, it should be possible to use equipment that is already available. The personalized mixes should be storage stable.

There is also a need to improve compliance to the suggested dosage recommendation by reducing the amount of product the customer needs to swallow. Currently available products go along with dosage recommendations of up to 10 g powder three times a day. Swallowing such high amount of powder is not a pleasurable experience and is likely to negatively impact compliance. Personalization of the current products should increase compliance or should at least not negatively impact compliance.

### SUMMARY OF THE INVENTION

The problems underlying the present invention are solved by manufacturing several varieties of edible particles that have at least one common active ingredient. Personalization is achieved by combining suitable amounts of selected varieties. Due to the common active ingredient(s), versatility is high and production cost is low. The volume of the thus manufactured personalized composition is low which increases compliance.

A preferred embodiment of the present invention relates to a composition comprising two or more varieties of edible particles, wherein the edible particles of a first variety comprise at least three active ingredients, and wherein the edible particles of a second variety comprise at least one active ingredient, and wherein the edible particles of said second variety comprises fewer active ingredients than the edible particles of said first variety, characterized in that the composition comprises at least one common active ingredient, said at least one common active ingredient being an active ingredient that is comprised in said first and in said second variety of edible particles.

The composition of the invention may be a mixture comprising the herein described edible particles. Alternatively, the two or more varieties of edible particles may be filled separately into single-serving packs. Preferred single-serving packs are stick packs.

The present invention also relates to a method of manufacturing a kit comprising single-serving packs, characterized in that edible particles of the first variety and edible particles of the second variety are filled into at least two single-serving packs. The kit of the present invention comprises at least two single-serving packs.

The present invention further relates to the use of two or more varieties of edible particles for providing at least one personalized composition. In a preferred embodiment, personalization is achieved by adapting the amount of the edible particles of the second variety.

### FIGURES

FIG. 1 shows the concept of the prior art: three kinds of particles are manufactured, comprising active ingredient A, B and C respectively. The upper part of FIG. 1 shows three boxes. The first box with letter “A” represents one unit of particles that comprise active ingredient A. The second box with letter “B” represents one unit of particles that comprise active ingredient B. The third box with letter “C” represents one unit of particles that comprise active ingredient C. Two personalized recipes are then given: 3 units A, 1 unit B and 1 unit C (first recipe for first consumer) and 2 units A, 2 units B and 1 unit C (second recipe for second consumer). Thus, the first recipe is a recipe for a first consumer that is in need of a relatively large amount of active ingredient A (3 units). Similarly, the second recipe is a recipe for a second consumer that needs the same amount of active ingredients A and B (2 units of each). The lower part of FIG. 1 shows how these recipes are achieved according to the prior art. The first consumer has to swallow three units A, one unit B and one unit C (first recipe, left arrow). Thus, in total, the first consumer needs to swallow 5 units. The second consumer has to swallow two units A, two units B and one unit C (second recipe, right arrow). Thus, both consumer 1 and consumer 2—have to swallow the same amount: 5 units in total each. In FIG. 1, “unit” is not further specified. One unit may be, for example, 3000 mg powder. In this case, both consumers would have to swallow 5×3000 mg powder=15000 mg powder. This is a large amount which is likely to negatively impact the compliance of consumers 1 and 2. Nobody is keen to swallow 15000 mg powder each day. To reduce the amount of powder to be swallowed, the concentration of the active ingredients in the particles could be increased. However, this is a theoretical solution only because it would be very difficult to measure small amounts of powders (e.g. 5 mg) with the required accuracy on conventional equipment.

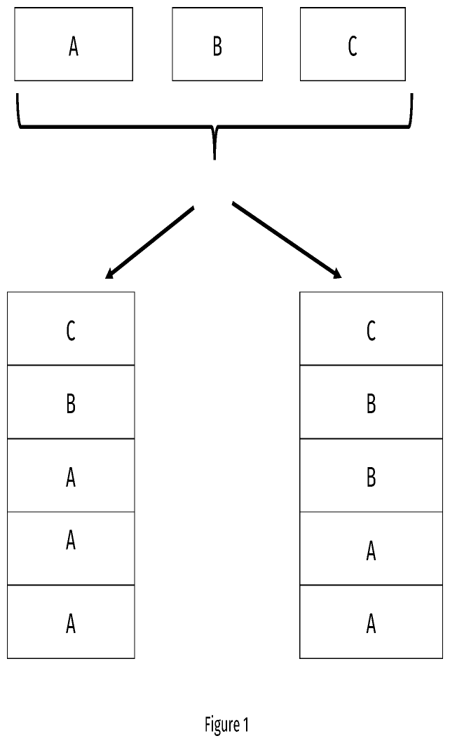

FIG. 2 shows an illustrative example of the concept of the present invention art: three varieties of particles are manufactured. The particles of the first variety comprise three active ingredients: A+B+C. The particles of the other two varieties comprise A and B respectively. The upper part of FIG. 2 shows three boxes. The first box with letters “A B C” represents one unit of particles of the first variety. The second box with letter “A” represents one unit of further variety of particles that comprise active ingredient A. This variety and the particles of the first variety have a common active ingredient being active ingredient A. The third box with letter “B” represents one unit of yet another variety of particles that comprise active ingredient B. This variety and the particles of the first variety have also a common active ingredient being active ingredient B. The same two personalized recipes of FIG. 1 are then given: 3 units A, 1 unit B and 1 unit C (first recipe for first consumer) and 2 units A, 2 units B and 1 unit C (second recipe for second consumer). The lower part of FIG. 2 shows how these two recipes are achieved when applying the concept of the invention: consumer 1 has to swallow one unit of particles of the first variety (“A B C”) and two units of the variety of particles that comprise active ingredient A (first recipe; left arrow). Thus, in total, consumer 1 has to swallow 3 units only. In comparison with the prior art (cf. FIG. 1), this is two units less. Consumer 2 has to swallow one unit of particles of the first variety (“A B C”), one unit of the variety of particles that comprise active ingredient A and one unit of the variety of particles that comprise active ingredient B (second recipe; right arrow). Thus, in total, consumer 2 has to swallow 3 units only. Again, this is two units less than shown in FIG. 1. Thus, FIG. 2 illustrates that the concept of “common active ingredient(s)” is a highly versatile system to allows to provide many different personalized compositions without the need to increase the amount of powder to be swallowed to an extend that negatively affects compliance. FIG. 2 also illustrates how to reduce the amount of powder to be swallowed without the need to measure very small amounts of powders: in comparison to FIG. 1 and assuming that 1 unit is 3000 mg, the total amount to be swallowed has been reduced from 15000 mg (FIG. 1) to 9000 mg (FIG. 2), whereas the smallest amount to be accurately measured has remained the same (3000 mg). Thus, when applying the solution of the invention, there is no need to invest in a new, sophisticated and thus expensive packaging line.

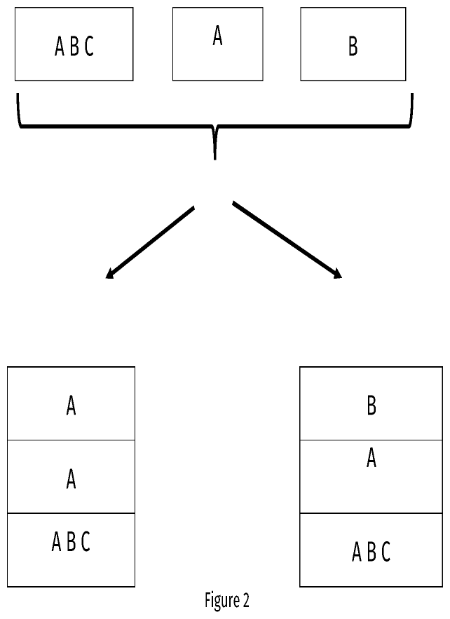

The present invention is not limited to the example shown in FIG. 2.

### DETAILED DESCRIPTION OF THE INVENTION

The present invention relates to varieties of edible particles that have at least one common active ingredient. Preferred active ingredients are macronutrients, micronutrients and other dietary ingredients known to have a positive impact on human health. Preferred micronutrients are water-soluble vitamins, fat-soluble vitamins, and minerals. Also preferred active ingredients are nutrients such as fatty acids, carbohydrates, fibers, amino acids and proteins. Also preferred active ingredients are bioactive substances selected from the group consisting of carotenoids, phenolics, alkaloids, saponins, glycosides, peptides and terpenes. In an alternative embodiment of the present invention, the term active ingredient excludes pharmaceutical drugs.

Edible particles as herein described may be manufactured as taught in the prior art. In one embodiment, edible particles are manufactured by hot-melt extrusion as disclosed in WO 2015/071394. The manufacturing of extruded edible particles is also disclosed in WO 2017/060320. Instead of extrusion, any known granulation method can be used for manufacturing the herein described edible particles. The particle size of extrudates and granulates is often larger than the size of particles that are obtained by spray-drying. Increasing particle size improves flowability. Good flowability due to larger particle size facilitates filling particles into stick-packs or any other single-serving packs. Edible particles as herein described are preferably not manufactured by spray-drying. Nevertheless, spray-dried particles may be used if agglomerated to larger granules or if coated such that the particle size is increased. The latter is disclosed e.g. in example 1 of WO 2017/055183. Increasing the particle size by agglomeration of spray-dried powders while spray-drying is known e.g. from manufacturing instant coffee. Conventional spray-drying does not involve such agglomeration. Edible particles of the prior art that are not storage stable are not preferred.

In one embodiment, the composition of the present invention comprises preferably at least 50%-weight, more preferably at least 70 weight-%, even more preferably at least 90 weight-% and most preferably at least 95 weight-% granules, based on the total weight of the composition, wherein said granules are preferably extrudates, milled particles or agglomerates, and wherein said agglomerates are more preferably agglomerated spray-dried particles. When granulating spray-dried particles that have already been storage stable before granulation, granules are obtained that are storage stable, too.

The composition of the present invention is not a nutrient duster as disclosed in US 2003/0170370. Thus, it is also not the heterogeneous nutrient duster of claim 1 of US 2003/0170370.

Edible particles of the present invention have preferably a sieve diameter in the range from 0.05 mm to 8 mm, which means that they, or at least 50 weight-% of the particles, based on the total weight of the particles, would pass through a sieve having an aperture or opening size of 8 mm, but not through a sieve having an aperture or opening size of 0.05 mm or less. Optionally, the edible particles of the invention may also have a sieve diameter in the range from 0.1 mm to 3 mm, or from 0.15 mm to 2.5 mm, or from 0.15 mm to 0.60 mm, such as 0.25±0.20 mm, 0.5±0.25 mm, 1.0±0.25 mm, 1.5±0.25 mm, or 2.0±0.25 mm, respectively. In some embodiments, the edible particles of the invention may even be larger, having a sieve diameter in the range from 0.1 mm to 10 mm, which means that they, or at least 50 weight-% of the particles, based on the total weight of the particles, would pass through a sieve having an aperture or opening size of 10 mm, but not through a sieve having an aperture or opening size of 0.1 mm or less. Typically, the edible particles of the invention have approximately spherical or cuboidal shape (i.e. an aspect ratio of longest space diagonal divided by shortest space diagonal anywhere in the range of 1 to 2.5); such edible particles have preferably a mass median sieve diameter in the range from 0.01 mm to 8 mm. In a not preferred embodiment, the edible particles of the invention are more elongated or platelet like shape (i.e. aspect ratios larger than 2.5); such not preferred edible particles may in some cases exceed the 8 mm and may have a mass median sieve diameter in the range from 0.01 mm up to 10 mm.

Common Active Ingredient

The composition of the present invention comprises two or more varieties of edible particles. Edible particles of the same variety comprise the same active ingredient(s) at preferably the same concentration(s). Edible particles of different varieties are not identical; preferably, they do not comprise the same active ingredient(s).

The composition and the kit of the invention comprise two or more varieties of edible particles. The edible particles of a first variety comprise at least three active ingredients. The edible particles of a second variety comprise fewer active ingredients than the edible particles of said first variety; however, edible particles of a second variety comprise at least one active ingredient.

Edible particles of the first and the second variety comprise at least one common active ingredient, wherein said at least one common active ingredient is an active ingredient that is comprised in said first and in said second variety of edible particles. In a preferred embodiment of the invention, there is one common active ingredient only. In another embodiment of the invention, there is more than one common active ingredient.

For illustration purposes, five exemplary embodiments (#1 to #5) of the invention are shown in below table.

| | Active ingredients | Active ingredients | |
|---|---|---|---|
| | comprised in | comprised in | Common |
| | edible particles | edible particles | active |
| | of first variety | of second variety | ingredient(s) |
| #1 | three fat-soluble | two fat-soluble | vitamin |
| | vitamins: | vitamins: | A and D |
| | vitamin A, E and D | vitamin A and D | |
| #2 | three fat-soluble | two fat-soluble | vitamin A |
| | vitamins: | vitamins: | |
| | vitamin A, E and D | vitamin A and K | |
| #3 | two fat-soluble | one fat-soluble | vitamin D |
| | vitamins: | vitamin: | |
| | vitamin A and D | vitamin D | |
| #4 | two water-soluble | one water-soluble | vitamin B6 |
| | vitamins: | vitamin: | |
| | vitamin C and B6 | vitamin B6 | |
| #5 | two water-soluble | one water-soluble | vitamin B6 |
| | vitamins and | vitamin: | |
| | one mineral: | vitamin B6 | |
| | vitamin C and B6 and a | | |
| | source of calcium ions | | |

Edible particles of the first variety comprise typically at least one active ingredient that is not a common active ingredient (e.g. above table #1, vitamin E). Edible particles of the second variety may comprise an active ingredient that is not a common active ingredient (e.g. above table #2, vitamin K). Alternatively, edible particles of the second variety do not comprise any active ingredient that is not a common active ingredient (e.g. above table #1 and #3 to #4). In a preferred embodiment of the invention, the edible particles of the second variety comprise no active ingredient other than the at least one common active ingredient (e.g. above table #3 to #5).

The concentration of a common active ingredient in the edible particles of the first and the second variety may be the same or may be different. The concentration of the common active ingredient in the edible particles of the first variety may be lower than the concentration of the common active ingredient in the edible particles of the second variety. In another embodiment of the invention, the concentration of the common active ingredient in the edible particles of the first variety may be higher than the concentration of the common active ingredient in the edible particles of the second variety.

To provide reasonable activity in the human body, a certain minimal concentration of an active ingredient is preferably achieved in the edible particles. The concentration of an active ingredient depends inter alia on the amount of excipient(s) that are present in the edible particle. Depending on the function of an excipient, relatively large amounts of excipients are often used (e.g. in case the excipient is a filler). In some case, excipients are added in low amounts only (e.g. in case the excipient is an antioxidant). An excipient being present in the second variety of edible particles at a concentration of preferably less than 0.01 weight-%, more preferably less than 0.005 weight-%, even more preferably less than 0.001 weight-%, and most preferably less than 0.0001 weight-%, based on the total weight of the second variety of edible particles, is preferably not considered as common active ingredient, even if said excipient is also present in the first variety of edible particles. For the same reason, a compound whose concentration in the second variety of edible particles is less than 5%, preferably less than 1%, more preferably less than 0.1% and most preferably less 0.01% of the concentration of the same compound in the first variety of edible particles, is preferably not considered as common active ingredient. Similarly, a compound whose concentration in the first variety of edible particles is less than 5%, preferably less than 1%, more preferably less than 0.1% and most preferably less 0.01% of the concentration of the same compound in the second variety of edible particles, is preferably not considered as common active ingredient. Other than that, the concentration of the at least one common active ingredient can be chosen as needed. In a preferred embodiment, however, the target concentration of a common active ingredient in the edible particles of the first variety is calculated as disclosed in step 4 of the preferred method of the present invention:
Step 1: provide at least two Recommended Daily Intakes (RDIs) as fixed by pre-determined national or regional authorities, for a pre-determined active ingredient being preferably a micronutrient or a macronutrient and being more preferably cholecalciferol
Step 2: choose the lowest RDI of the RDIs provided in step 1
Step 3: provide a pre-determined weight, wherein said weight is preferably from 30 mg to 3000 mg, more preferably from 30 mg to 2500 mg, even more preferably from 100 mg to 2000 mg and most preferably from 200 mg to 1000 mg
Step 4: calculate a concentration for the active ingredient of step 1 for edible particles as follows:

$$\frac{R D I of step 2 * 1 day}{pre - determined weight of step 3}$$

Step 5: provide two or more varieties of edible particles, wherein the edible particles of a first variety comprise the active ingredient of step 1 at the concentration calculated in step 4, based on the total weight of the edible particles of the first variety, and wherein the edible particles of a second variety comprise at least the active ingredient of step 1, with the proviso that the edible particles of the second variety comprise fewer active ingredients than the edible particles of the first variety.

When following this method, the weight and/or volume of the personalized composition that needs to be swallowed by an individual consumer is particularly low, regardless which of the pre-determined RDIs is applicable for the consumer.

In the context of the invention, “target concentration” means that the concentration of the respective active ingredient in the edible particle is preferably ±20%, more preferably ±10% and most preferably is ±5% of the target concentration. Thus, target concentration is preferably a calculated value which gives guidance for the manufacturing of the actual edible particles.

In the context of the invention's method, “Recommended Dietary Intake” or “RDI” is used for formulation purposes. Such use of RDI is novel and very unconventional. The actual amount of an active ingredient that a consumer will ingest depends mostly on the amount of edible particles that he swallows and less on the concentration of the active ingredient in the edible particle: the more particles a consumer swallows, the higher the dosage. Therefore, “Recommended Dietary Intake” or “RDI” is herein to be understood in a very broad manner. In the context of the present invention, RDI may be replaced by Adequate Intake (AI), Recommended Dietary Allowance (RDA), Advisable Daily Intake (ADI), Nutrient Reference Value (NRV) or Estimated Average Requirement (EAR) if an active ingredient's RDI value is not available for a specific people group in a specific country. The Adequate Intake (AI), for example, was developed where EAR and RDA could not be set due to insufficient scientific evidence. RDIs for active ingredients are set by national or regional authorities and may therefore change over time. Preferably, the most recent (i.e. the current) value of a specific RDI is used in the method of the present invention. However, because the RDI is only used for guiding a company's formulation department towards a suitable target concentration, the method of the present invention also works if the penultimate (i.e. an outdated) value of a specific RDI is used. The preferred method of the invention is further illustrated by below tables and below preferred embodiments:

Vitamin A for pregnant female 30 years old

| | | |
|---|---|---|
| Step 1 | RDI USA (RDA¹) | 770 μg/day |
| | RDI Australia (RDI) | 800 μg/day |

| | |
|---|---|
| Step 2 | 770 μg/day |
| Step 3 | 200 mg |
| Step 4 | [(0.770 mg/day)*1 day]/200 mg = 0.385 weight-% |
| | vitamin A, based on the total weight of the |
| | edible particles of the first variety |

Thus, a preferred embodiment of the invention relates to a composition comprising a first and a second variety of edible particles, wherein the edible particles of the first variety comprise:
at least three fat-soluble vitamins, wherein one of said three fat-soluble vitamins is vitamin A or provitamin A, and
at least one matrix material

and wherein the edible particles of the second variety comprise:
less than three fat-soluble vitamins, with the proviso that the edible particles of the second variety comprise at least vitamin A, and
at least one matrix material,

and wherein said provitamin A is preferably beta-carotene,

characterized in that the edible particles of the second variety comprise preferably from 0.01 weight-% to 2 weight-%, more preferably from 0.05 weight-% to 1 weight-% and most preferably from 0.1 weight-% to 1 weight-% vitamin A or provitamin A, based on the total weight of the edible particles of the first variety.

Vitamin D for adult male 20 years old

| | | |
|---|---|---|
| Step 1 | RDI Europe (DRV²) | 15 μg/day |
| | RDI Japan (AI³) | 5.5 μg/day |

| | |
|---|---|
| Step 2 | 5.5 μg/day |
| Step 3 | 100 mg |
| Step 4 | [(0.0055 mg/day)*1 day]/100 mg = 0.0055 weight-% |
| | vitamin D, based on the total weight of the |
| | edible particles of the first variety |

Thus, a preferred embodiment of the invention relates to a composition comprising a first and a second variety of edible particles, wherein the edible particles of the first variety comprise:
at least three fat-soluble vitamins, wherein one of said three fat-soluble vitamins is vitamin D, and
at least one matrix material

and wherein the edible particles of the second variety comprise:
less than three fat-soluble vitamins, with the proviso that the edible particles of the second variety comprise at least vitamin D, and
at least one matrix material,

and wherein said vitamin D is preferably cholecalciferol,

characterized in that the edible particles of the second variety comprise preferably from 0.001 weight-% to 0.1 weight-%, more preferably from 0.001 weight-% to 0.05 weight-% and most preferably from 0.001 weight-% to 0.01 weight-% vitamin D, based on the total weight of the edible particles of the first variety.

Vitamin E for adult female 50 years old

| | | |
|---|---|---|
| Step 1 | RDI US (RDA⁴) | 15 mg/day |
| | RDI Australia (AI⁵) | 7 mg/day |

| | |
|---|---|
| Step 2 | 7 mg/day |
| Step 3 | 140 mg |
| Step 4 | [(7 mg/day)*1 day]/140 mg = 5 weight-% |
| | vitamin E, based on the total weight of the |
| | edible particles of the first variety |

Thus, a preferred embodiment of the invention relates to a composition comprising a first and a second variety of edible particles, wherein the edible particles of the first variety comprise:
at least three fat-soluble vitamins, wherein one of said three fat-soluble vitamins is vitamin E, and
at least one matrix material

and wherein the edible particles of the second variety comprise:
less than three fat-soluble vitamins, with the proviso that the edible particles of the second variety comprise at least vitamin E, and
at least one matrix material,

and wherein said vitamin E is preferably a vitamin E ester such as tocopheryl acetate,

characterized in that the edible particles of the second variety comprise preferably from 0.1 weight-% to 20 weight-%, more preferably from 1 weight-% to 15 weight-% and most preferably from 5 weight-% to 10 weight-% vitamin E, based on the total weight of the edible particles of the first variety.

Vitamin K for female 71 years old

| | | |
|---|---|---|
| Step 1 | RDI Japan (AI⁵) | 150 μg/day |
| | RDI Australia (AI⁷) | 60 μg/day |

| | |
|---|---|
| Step 2 | 60 μg/day |
| Step 3 | 180 mg |
| Step 4 | [(0.060 mg/day)1 day]/180 mg = 0.033 weight-% |
| | vitamin K, based on the total weight of the |
| | edible particles of the first variety |

Thus, a preferred embodiment of the invention relates to a composition comprising a first and a second variety of edible particles, wherein the edible particles of the first variety comprise:
at least three fat-soluble vitamins, wherein one of said three fat-soluble vitamins is vitamin K, and
at least one matrix material

and wherein the edible particles of the second variety comprise:
less than three fat-soluble vitamins, with the proviso that the edible particles of the second variety comprise at least vitamin K, and
at least one matrix material,

and wherein said vitamin K is preferably vitamin K1 or vitamin K2,

characterized in that the edible particles of the second variety comprise preferably from 0.001 weight-% to 0.1 weight-%, more preferably from 0.001 weight-% to 0.05 weight-% and most preferably from 0.01 weight-% to 0.05 weight-% vitamin K, based on the total weight of the edible particles of the first variety.

Composition of the Invention

The composition of the present invention comprises two or more varieties of edible particles that are preferably provided by the herein described method comprising steps 1 to 5. In a preferred embodiment, the composition is a mixture of two or more varieties of edible particles. Such mixture may be a powder that can be filled in single-serving packs such as stick-packs. Alternatively, such mixture may be particles (e.g. granules) that can be sprinkled over food. In yet another embodiment, such mixture is water-soluble or water-dispersible and thus, can be used to prepare beverages. In a further embodiment, the mixture can be filed in two-piece capsules (e.g. hard gelatin capsules) or can be compressed into tablets, together with suitable tableting aids.

Filling powder into stick-packs is particularly easy if the powder to be filled in has a weight of at least 30 mg (cf. step 3 of the method comprising steps 1 to 5). In one embodiment, the composition of the present invention comprises two or more varieties of particles, wherein the weight of each variety's particles is from 30 mg to 3000 mg, preferably from 30 mg to 2500 mg, more preferably from 100 mg to 2000 mg and most preferably from 200 mg to 1000 mg, such that the total weight of the composition is at least 60 mg, preferably at least 200 mg and most preferably at least 400 mg. In another preferred embodiment, the volume of each variety's particles is from 0.05 ml to 5 ml, preferably from 0.1 ml to 2 ml, more preferably 0.1 ml to 1.5 ml and most preferably from 0.2 ml to 1 ml, such that the total volume of the composition is at least 0.1 ml, preferably at least 0.2 ml and most preferably at least 0.4 ml.

Edible particles of the first variety and edible particles of the second variety may be mixed at any ratio. Typically, the amount of edible particles of the first variety exceeds the amount of edible particles of the second variety. In one embodiment of the present invention, the weight ratio between the edible particles of the first variety and the edible particles of the second variety is from 20:1 to 1:1, preferably from 20:1 to 2:1, more preferably from 15:1 to 2:1 and most preferably from 10:1 to 3:1. The composition of the present invention comprises preferably at least 10 mg, more preferably at least 15 mg, even more preferably at least 20 mg and most preferably at least 25 mg of the second variety of edible particles.

Kit of the Invention

In one embodiment of the present invention, the first and the second variety of edible particles are separated from one another (instead of being mixed). In this embodiment, the first and the second variety of edible particles are preferably filled into separate single-serving packs. Then, to achieve the recommended amount of the respective active ingredients, an individual consumer or a member of a pre-determined group of consumers ingests the content of at least two non-identical single-serving packs. Preferably, one single-serving pack contains the first variety of edible particles whereas the other of the at least two single-serving packs contains the second variety of edible particles. Thus, the present invention also relates to kit comprising at least two single-serving packs, characterized in that the first and the second variety of edible particles are separated from one another. The two or more varieties of edible particles of such kit that are preferably provided by the herein described method comprising steps 1 to 5.

Methods of the Invention

The present invention relates to the herein described method for providing two or more varieties of edible particles. The preferred method comprises herein described steps 1 to 5.

The present invention also relates a method of manufacturing of a kit comprising single-serving packs, characterized in that edible particles of a first variety and edible particles of a second variety are filled into at least two single-serving packs, wherein the edible particles of the first variety comprise at least three active ingredients, and wherein the edible particles of the second variety comprise at least one active ingredient, and wherein the edible particles of said second variety comprises fewer active ingredients than the edible particles of said first variety, and characterized in that the edible particles of the first and the second variety comprise at least one common active ingredient, said at least one common active ingredient being an active ingredient that is comprised in said first and in said second variety of edible particles.

This method can be run on a conventional stick-pack filling machine or on a more sophisticated packaging line. To fill less than 30 mg powder into each stick-pack, a more advanced packing line might be needed. Precision powder micro-dosing systems are commercially available at Capsugel® (now a Lonza® company).

A preferred embodiment of the present invention relates to a method for providing a composition which comprises two or more varieties of edible particles, said method comprising the steps:
Step 1: provide at least two Recommended Daily Intakes (RDIs) as fixed by pre-determined national or regional authorities, for a pre-determined active ingredient being preferably a micronutrient or a macronutrient and being more preferably cholecalciferol
Step 2: choose the lowest RDI of the RDIs provided in step 1
Step 3: provide a pre-determined weight, wherein said weight is preferably from 30 mg to 3000 mg, preferably from 30 mg to 2500 mg, more preferably from 100 mg to 2000 mg and most preferably from 200 mg to 1000 mg
Step 4: calculate a concentration for the active ingredient of step 1 for edible particles as follows:

$$\frac{R D I of step 2 * 1 day}{pre - determined weight of step 3}$$

Step 5: provide two or more varieties of edible particles, wherein the edible particles of a first variety comprise the active ingredient of step 1 at the concentration calculated in step 4, based on the total weight of the edible particles of the first variety, and wherein the edible particles of a second variety comprise at least the active ingredient of step 1, with the proviso that the edible particles of the second variety comprise fewer active ingredients than the edible particles of the first variety.

In said method for providing a composition, the pre-determined active ingredient is preferably a micronutrient or a macronutrient as herein disclosed. The herein disclosed weight ratios and other preferences also apply.

Use of the Invention

The present invention also relates to the use of two or more varieties of edible particles as herein described for providing at least one personalized composition. If two or more varieties of edible particles are on stock, many different personalized compositions can be provided by choosing suitable amounts of the respective variety. A preferred embodiment of the invention relates to the use of two or more varieties of edible particles for providing at least one personalized composition, wherein the edible particles of a first variety comprise at least three active ingredients, and wherein the edible particles of a second variety comprise at least one active ingredient, and wherein the edible particles of said second variety comprises fewer active ingredients than the edible particles of said first variety, characterized in that the edible particles of the first and the second variety comprise at least one common active ingredient, said at least one common active ingredient being an active ingredient that is comprised in said first and in said second variety of edible particles.

Preferably, the edible particles of the first variety comprise at least one, preferably at least two active ingredients which are bought by at least 60% of those US consumers which have been buying dietary supplements at least twice per year from 2017 to 2019. Because a majority of consumers needs at least one of those wide-spread active ingredients, the amount of edible particles of the first variety may be the same for at least two different groups of consumers (e.g. men, women, children and people aged 60 years and older). Personalization may then be achieved by adapting the amount of the edible particles of the second variety to the needs of an individual consumer or to the needs of a member of a pre-determined group of consumers. This concept is illustrated in a simplified manner in FIG. 2.

In one embodiment of the invention, the herein described edible particles of the first variety comprise at least one, preferably at least two and most preferably at least three fat-soluble vitamins preferably selected from the group consisting of vitamin A, provitamin A, vitamin E, vitamin D and vitamin K. In another embodiment, the herein described edible particles of the first variety comprise at least one, preferably at least two and most preferably at least three water-soluble active ingredients preferably selected from the group consisting of vitamin C, thiamin, riboflavin, niacin, vitamin B6, pantothenic acid, vitamin B12, vitamin B9 and biotin. In yet another embodiment, the herein described edible particles of the first variety comprise at least one, preferably at least two and most preferably at least three minerals preferably selected from the group consisting of sources of calcium ions, sources of magnesium ions, sources of zinc ions, sources of iodine, sources of selenium ions, sources of chromium ions, sources of copper ions, sources of iron ions, sources of manganese ions, sources of molybdenum ions, sources of potassium ions and sources of phosphorus ions. In these preferred embodiments, the target concentration of the respective micro- or macronutrient is preferably determined as disclosed in step 4 of the herein disclosed method.

### EXAMPLES

### Example 1

Example 1 illustrates the technical limitations of conventional stick-pack filling machines.

In some countries, the recommended daily intake (RDI) of vitamin D (cholecalciferol) is 0.015 mg. This corresponds to 6 mg of a spray-dried powder that comprises cholecalciferol at a concentration of 0.25 weight-%, based on the total weight of the powder. Such powder is available at DSM® Nutritional Products (Switzerland).

The goal of Example 1 is to manufacture 1000 stick-packs, each stick-pack comprising 6 mg vitamin D powder.

Example 1 fails. On a conventional packaging machine, it is not possible to fill 6 mg powder in each sachet: the volume corresponding to 6 mg powder is too small to be handled by conventional stick-pack filling machines. A very sophisticated and thus very expensive packaging machine would be needed to precisely measure 6 mg powder.

### Example 2

In Example 2, granules comprising 0.01 weight-% vitamin D (cholecalciferol), based on the total weight of the granule, are manufactured. To reach the recommended daily vitamin D intake of 0.015 mg, 150 mg of these granules are needed.

The goal is to manufacture 1000 stick-packs, each stick-pack comprising 150 mg of the vitamin D powder of Example 2. This goal is achievable. On a commercially available packaging machines, it is possible to fill 150 mg powder in each sachet. 150 mg powder corresponds to a weight and/or volume large enough to be handled by a commercially available stick-pack filling machine. 150 mg is 25 times more than what is needed in Example 1.

Example 2 shows that the technical limitation of packaging machines can be overcome by providing powder with a lower concentration of the active ingredient. The disadvantage of such dilution strategy is an increased amount of powder that needs to be swallowed.

### Example 3

In Example 3, three varieties of edible particles (1, 2a and 2c) are manufactured in addition to the particles of Example 2 (variety 2b). The corresponding compositions are shown in below table 1. In comparison, the powder Example 1 is also shown.

TABLE 1

| | | | Particles | | |
|---|---|---|---|---|---|
| | Particles | Particles | Variety 2b | Particles | powder of |
| | Variety 1 | Variety 2a | (Example 2) | Variety 2c | Example 1 |
| Vitamin A | 0.45 | 0.1 | — | — | — |
| | weight-% | weight-% | | | |
| Vitamin D | 0.01 | — | 0.01 | — | 0.25 |
| | weight-% | | weight-% | | weight-% |
| Vitamin E | 7.5 | — | — | 7.5 | — |
| | weight-% | | | weight-% | |
| Matrix material and | 92.04 | 99.9 | 99.99 | 92.5 | 99.75 |
| other excipients | weight-% | weight-% | weight-% | weight-% | weight-% |

The particles of variety 1 to 2c are preferably manufactured by granulation (e.g. fluid-bed granulation) or by extrusion. When using such method, the obtained granules are significantly larger than conventional spray-dried particles. The increased size of granules increases flowability. Flowability facilitates precise metering of powders. The powder of Example 1 is a conventional spray-dried powder having a small particle size.

### Example 4

In Example 4, three personalized recipes for dietary supplements are identified for three individuals (Pete, Sara and Monica) as shown in below table 2:

TABLE 2

| | Pete (72 years | | Sara (50 years | | Monica (22 years | |
|---|---|---|---|---|---|---|
| | old male, | | old female, | | old, pregnant, | |
| | US resident) | | US resident) | | US resident) | |
| Vitamin A | 900 | μg/day | 700 | μg/day | 770 | μg/day |
| Vitamin D | 20 | μg/day | 15 | μg/day | 15 | μg/day |
| Vitamin E | 15 | mg/day | 15 | mg/day | 15 | mg/day |

Each individual needs a different amount of vitamin A. Sara and Monica need the same amount of vitamin D, while Pete needs a higher amount because he is above the age of 70. On the other hand, all 3 individuals need the same amount of vitamin E.

There are various reasons for different individualized nutrient recommendations such as age, sex, life stage, recommendation of national health organizations, health status, pregnancy, genotype and others.

### Example 4a (Pete)

When using the products of Example 3, there are the following options to meet Pete's need:

Option 1a

| | Dosage regimen | | |
|---|---|---|---|
| | for Pete | | Vitamin content |
| Particles Variety 1 | 200 | mg/day | 200 mg *0.45 weight-% |
| | | | *1000 = 900 μg vitamin A |
| | | | 200 mg *0.01 weight-% |
| | | | *1000 = 20 μg vitamin D |
| | | | 200 mg *7.5 weight-% = |
| | | | 15 mg vitamin E |
| Total amount of | 200 | mg | |
| powder per day | | | |

Option 2a

| | Dosage regime | | |
|---|---|---|---|
| | for Pete | | Vitamin content |
| Particles variety 1 | — | | |
| Particles Variety 2a | 900 | mg/day | 900 mg *0.1 weight-% |
| | | | *1000 = 900 μg vitamin A |
| Particles Variety 2b | 200 | mg/day | 200 mg *0.01 weight-% |
| | | | *1000 = 20 μg vitamin D |
| Particles Variety 2c | 200 | mg/day | 200 mg *7.5 weight-% = |
| | | | 15 mg vitamin E |
| Total amount of | 1300 | mg | |
| powder per day | | | |

Option 3a

| | Dosage regime | |
|---|---|---|
| | for Pete | Vitamin content |
| Particles variety 1 | — | — |
| Particles Variety 2a | — | — |
| Particles Variety 2a | 900 mg/day | 900 mg *0.1 weight-% |
| | | *1000 = 900 μg vitamin A |
| Powder of Example 1 | 8 mg/day | 8 mg *0.25 weight-% |
| | | *1000 = 20 μg vitamin D |
| Particles Variety 2c | 200 mg/day | 200 mg *7.5 weight-% = |
| | | 15 mg vitamin E |
| Total amount of | 1108 mg/day | |
| powder per day | | |

Option 1a is preferred over option 2a because Pete needs to swallow less powder. At first sight, increasing the concentration of the micronutrients seems a good strategy to reduce the amount of powder that Pete needs to swallow. In Option 3a, the concentration of vitamin D is 25×higher than in Particles Variety 2b. Whereas such increase in concentration indeed reduces the amount of powder (reduction from 1300 mg to 1108 mg), it might result in a very expensive or even in a non-workable approach: as shown in Example 1, filling 8 mg powder into a sachet is difficult on a conventional packaging machine. A more sophisticated and thus more expensive packaging solution would be needed for executing Option 3.

Clearly, the preferred solution for Pete's need is 200 mg/day of Particles Variety 1. However, Particles Variety 1 do not meet Sara's and Monica's needs. Manufacturing a specific variety of particles for each individual is not promising due to cost reasons and also due to capacities in manufacturing facilities. Moving away from the all-fits-one approach requires many different recipes and thus, many different products.

### Example 4b (Sara)

When using the products of Example 3, there are the following options to meet Sara's need:

Option 1b (does not meet Sara's needs)

| | Dosage regimen | | |
|---|---|---|---|
| | for Sara | | Vitamin content |
| Particles Variety 1 | 200 | mg/day | 200 mg *0.45 weight-% |
| | | | *1000 = 900 μg vitamin A (over |
| | | | Sara's vitamin A requirement) |
| | | | 200 mg *0.01 weight-% |
| | | | *1000 = 20 μg vitamin D (over |
| | | | Sara's vitamin D requirement) |
| | | | 200 mg *7.5 weight-% = |
| | | | 15 mg vitamin E |
| Total amount of | 200 | mg | |
| powder per day | | | |

Option 1b shows that personalization is limited when using one variety of particles only. When using particles of variety 1 only, Sara's personalized needs for vitamin D and vitamin A will be exceeded. If the daily serving of granules is decreased below 200 mg, Sara's vitamin E needs will not be met.

Option 2b (vitamin E as common micronutrient)

| | Dosage regimen | | |
|---|---|---|---|
| | for Sara | | Vitamin content |
| Particles Variety 1 | 156 | mg/day | 156 mg *0.45 weight-% |
| | | | *1000 = 700 μg vitamin A |
| | | | 156 mg *0.01 weight-% |
| | | | *1000 = 15.6 μg vitamin D |
| | | | 156 mg *7.5 weight-% = |
| | | | 11.7 mg vitamin E |
| Particles Variety 2c | 44 | mg/day | 44 mg *7.5 weight-% = |
| | | | 3.3 mg vitamin E |
| Total amount of | 200 | mg | |
| powder per day | | | |

Option 2b shows that personalization is possible when two varieties of particles are mixed upon filing into stick-packs. The amount of vitamin E missing in Particles Variety 1 is added through admixture with a suitable amount of Particles Variety 2c. The particles of both varieties (Particles Variety 1 and Particles Variety 2c) comprise vitamin E, i.e. vitamin E is common to both varieties. This is referred to as “common micronutrient”. The particles of the two varieties differ in the concentration of vitamin E.

The approach of a “common micronutrient” is applicable to many hundreds of personalized recipes that differ in the amount of vitamin E. Thus, the approach of option 2b is more than just a solution for Sara.

156 mg powder and 44 mg powder are volumes that are large enough to be handled by commercially available machines for filling stick packs. Thus, option 2b can be implemented on existing equipment and is therefore a cost-effective solution.

Mixing 156 mg with 44 mg results in 200 mg powder mixture. 200 mg powder is an amount that Sara can easily swallow. Therefore, Sara is likely to show good compliance to her tailored dosage regimen.

Option 3b (comparative example)

| | Dosage regimen | | |
|---|---|---|---|
| | for Sara | | Vitamin content |
| Particles variety 1 | — | | |
| Particles Variety 2a | 700 | mg/day | 700 mg *0.1 weight-% |
| | | | *1000 = 700 μg vitamin A |
| Particles Variety 2b | 150 | mg/day | 150 mg *0.01 weight-% |
| | | | *1000 = 15 μg vitamin D |
| Particles Variety 2c | 200 | mg/day | 200 mg *7.5 weight-% = |
| | | | 15 mg vitamin E |
| Total amount of | 1050 | mg | |
| powder per day | | | |

In Option 3b, there is no common micronutrient. Each particle variety comprises one micronutrient only. At first sight, this seems to be an excellent solution as it gives maximum flexibility for providing personalized mixtures. A more detailed analysis, however, shows that Sara is meant to swallow 1050 mg powder each day. This is very unpleasant. Sara might stop the recommended dosage regimen. Thus, patient compliance might be poor.

The large amount of powder is due to the limitations of packaging machines. Concentrations of micronutrients need to be low to have amounts of powder that are high enough to be filled into stick-packs with conventional packaging machines.

### Example 4c (Monica)

When using the products of Example 3, Monica's needs can be met as follows:

TABLE 3

| | Dosage regimen | | |
|---|---|---|---|
| | for Monica | | Vitamin content |
| Particles Variety 1 | 150 | mg/day | 150 mg *0.45 weight-% |
| | | | *1000 = 675 μg vitamin A |
| | | | 150 mg *0.01 weight-% |
| | | | *1000 = 15 μg vitamin D |
| | | | 150 mg *7.5 weight-% = |
| | | | 11.25 mg vitamin E |
| Particles Variety 2a | 95 | mg/day | 95 mg *0.1 weight-% |
| | | | *1000 = 95 μg vitamin A |
| Particles Variety 2c | 50 | mg/day | 50 mg *7.5 weight-% = |
| | | | 3.75 mg vitamin E |
| Total amount of | 295 | mg | |
| powder per day | | | |

In Example 4c, particles of three varieties are mixed. The thus obtained mixture is filled into stick-packs. Monica receives a supply of 100 stick-packs for 100 days. Monica swallows 295 mg per day. She can easily do so and will therefore comply with her personalized dosage regimen.

The mixture of Example 4c has more than one common micronutrient:

The particles of variety 1 and of variety 2a comprise vitamin A. Vitamin A is common to both varieties, i.e. is a common micronutrient. In Particles Variety 1, the concentration of vitamin A is slightly higher than the concentration in Particles Variety 2a. This helps reducing the amount of powder Monica needs to swallow.

The particles of variety 1 and of variety 2c comprise vitamin E. Vitamin E is common to both varieties, i.e. is a common micronutrient. The particles of the two varieties do not differ in the concentration of vitamin E. Thus, a difference in concentration is not necessary to solve the problems underlying the present invention.

### Example 5 (Us Vs. Japanese Requirements)

Recommended daily intakes (RDI) of micronutrients is fixed by national or regional authorities. For some micronutrients, RDIs vary significantly from one region to another.

For USA and Japan, the recommended daily intake (RDI) of vitamin A is the same (900 μg/day), whereas the RDIs for vitamin D differ significantly: the US Recommended Dietary Allowance (RDA) of vitamin D (cholecalciferol) is 15 μg/day. In Japan, the Adequate Intake (AI) of vitamin D is significantly lower (5.5 μg/day). This is summarized in below table 4.

TABLE 4

Recommended Daily Intake (RDI)
for men, 30 years old

| | Vitamin A | Vitamin D | |
|---|---|---|---|
| US | 900 μg (RDA) | 15 | μg (RDA) |
| Japan | 900 μg (RDA) | 5.5 | μg (AI) |

Despite these differences, the compositions of Example 3 can also be used for Japan. This is illustrated by below tables 5a and 5b. There is no need to manufacture further particles.

TABLE 5a

| | Composition comprising particles variety 1 | | |
|---|---|---|---|
| | | | Total amount |
| | Particles | Particles | of respective |
| Japan | Variety 1 | Variety 2a | vitamin |
| Vitamin D | 55 mg * 0.01 weight-% | 0 | 5.5 μg |
| | vitamin D *1000 = | | Vitamin D |
| | 5.5 μg Vitamin D | | |
| Vitamin A | 55 mg * 0.45 weight-% | 652.5 mg * 0.1 | 247.5 μg + |
| | vitamin A *1000 = | weight-% vitamin | 652.5 μg = |
| | 247.5 μg Vitamin A | A = 652.5 μg | 900 μg |
| | | Vitamin A | Vitamin A |

TABLE 5b

| | | | |
|---|---|---|---|
| total weight of | 55 | mg | particles variety 1 |
| composition comprising | +652.5 | mg | particles variety 2a |
| particles variety 1 | =707.5 | mg | total weight of composition |

Example 5 shows the flexibility of the solution of the invention. The very low Japanese RDI for vitamin D can be taken account of by reducing the amount of particles variety 1 from 200 mg (cf. Example 4a) to 55 mg. Because the particles variety 1 comprise more than one micronutrient, the amount of the other micronutrient (i.e. vitamin A) is also reduced. In Example 5, the amount of vitamin A is reduced from 900 μg⁸ (cf. Example 4a) to 247.5 μg⁹ when reducing the amount of particles variety 1 from 200 mg to 55 mg. This can be compensated by adding 652.5 mg of particles variety 2a.

55 mg is an amount high enough to be measured on a conventional filling machine. In example 5, the Japanese consumer needs to swallow 707.5 mg powder, which is still acceptable.

### Example 6 (Preferred Embodiment)

Example 6 is a preferred embodiment that considers the high variability of national and regional RDIs.

In Example 6, an alternative to the particles variety 1 is produced. In said alternative, the concentration of vitamin D is only 27.5% of that contained in the “normal” particles variety 1 (0.00275 weight-% instead of 0.01 weight-%). This is shown in below table 6.

TABLE 6

| | |
|---|---|
| Alternative | Particles |
| Particles Variety 1 | Variety 1 |

| | | | | |
|---|---|---|---|---|
| Vitamin D | 0.00275 | weight-% | 0.01 | weight-% |
| Vitamin E | 7.5 | weight-% | 7.5 | weight-% |
| Vitamin A | 0.45 | weight-% | 0.45 | weight-% |
| Matrix material and | 92.04725 | weight-% | 92.04 | weight-% |
| other excipients | | | | |

When using alternative particles variety 1, the requirements of Japanese RDI of vitamins D and A can be met by administering only 200 mg powder. This is significantly less than the 707.5 mg powder of Example 5. As a summary, see below tables 7a and 7b.

TABLE 7a

| | Composition comprising alternative particles variety 1 | | |
|---|---|---|---|
| | | | Total amount |
| | Alternative | Particles | of respective |
| Japan | Particles Variety 1 | Variety 2b | vitamin |
| Vitamin D | 200 mg * 0.00275 weight-% | 0 mg | 5.5 μg Vitamin D |
| | vitamin D *1000 = 5.5 μg | | |
| | Vitamin D | | |
| Vitamin A | 200 mg * 0.45 weight-% | 0 mg | 900 μg Vitamin A |
| | vitamin A *1000 = 900 μg | | |
| | Vitamin A | | |

TABLE 7b

| | | | |
|---|---|---|---|
| total weight of | 200 | mg | alternative particles variety 1 |
| composition comprising | +0 | mg | particles variety 2b |
| alternative particles | =200 | mg | total weight of composition |
| variety 1 | | | |

Alternative particles variety 1 can also be used to meet the requirements of US RDI, as illustrated by below tables 8a and 8b.

TABLE 8a

| | Composition comprising alternative particles variety 1 | | |
|---|---|---|---|
| | | | Total amount |
| | Alternative | Particles | of respective |
| US | Particles Variety 1 | Variety 2b | vitamin |
| Vitamin D | 200 mg * 0.00275 | 95 mg *0.01 | 15 μg Vitamin D |
| | weight-% vitamin D = | weight-% = 9.5 | |
| | 5.5 μg Vitamin D | μg vitamin D | |
| Vitamin A | 200 mg * 0.45 | 0 | 900 μg Vitamin A |
| | weight-% vitamin A = | | |
| | 900 μg Vitamin A | | |

TABLE 8b

| | | | |
|---|---|---|---|
| total weight of | 200 | mg | alternative particles variety 1 |
| composition comprising | +95 | mg | particles variety 2b |
| alternative particles | =295 | mg | total weight of composition |
| variety 1 | | | |

A total of 295 mg powder is still a very low amount of powder.

Example 6 illustrates a preferred manner for determining the target concentration of a common active ingredient when manufacturing particles variety 1:
Step 1: provide at least two RDIs for a common active ingredient, as fixed by a national or regional authority
Step 2: choose the lowest RDI of the RDIs provided in step 1
Step 3: provide a pre-determined weight, e.g. 200 mg
Step 4: calculate the target concentration of the common active ingredient of step 1 in particles variety 1 as follows:

$$\frac{R D I of step 2 * 1 day}{pre - determined weight of step 4}$$

In Example 6, the target concentration of vitamin D is
[(5.5 μg/day)/1000*1 day]/200 mg=0.00275 weight-% vitamin D, based on the total weight of particles variety 1.

1. A composition comprising a plurality of edible particles of two or more varieties, wherein
edible particles of a first variety comprise at least three active ingredients, and edible particles of a second variety comprise at least one active ingredient,
wherein the edible particles of said second variety comprise fewer active ingredients than the edible particles of said first variety, and
wherein the edible particles of the first variety and the edible particles of the second variety comprise at least one common active ingredient, said at least one common active ingredient being an active ingredient that is comprised in said first and in said second variety of edible particles.

2. The composition according to claim 1, wherein the edible particles of the second variety comprise no active ingredient other than the at least one common active ingredient.

3. The composition according to claim 1, wherein the edible particles of the second variety comprise an excipient at a concentration of less than 0.01 weight-%, the excipient not being a common active ingredient, even if also present in the first variety of edible particles.

4. The composition according to claim 1, wherein the weight ratio between the edible particles of the first variety and the edible particles of the second variety is from 20:1 to 1:1 and wherein the composition comprises at least 10 mg of the edible particles of the second variety.

5. The composition according to claim 1, wherein the edible particles of the first variety have a weight of from 200 mg to 1000 mg.

6. The composition according to claim 1, wherein the edible particles of the first variety comprise at least 20 weight-% of at least one edible excipient, based on the total weight the edible particles of the first variety, and wherein the edible particles of the second variety comprise at least 55 weight-%, of at least one edible excipient, based on the total weight the edible particles of the second variety.

7. The composition according to claim 1, wherein the composition comprises at least 50%-weight granules, based on the total weight of the composition, and wherein said granules are extrudates.

8. The composition according to claim 1, wherein said at least one common active ingredient is a macronutrient or a micronutrient.

9. The composition according to claim 1, wherein the edible particles of the first variety comprise at least three fat-soluble vitamins selected from the group consisting of vitamin A, provitamin A, vitamin D, vitamin E and vitamin K, or wherein the edible particles of the first variety comprise at least three water-soluble vitamins selected from the group consisting of vitamin C, thiamin, riboflavin, niacin, vitamin B6, pantothenic acid, vitamin B9 vitamin B12, biotin and choline.

10. The composition according to claim 1, wherein the edible particles of the first variety comprise:
at least three fat-soluble vitamins, wherein one of said three fat-soluble vitamins is vitamin E, and
at least one matrix material
and wherein the edible particles of the second variety comprise:
less than three fat-soluble vitamins, with the proviso that the edible particles of the second variety comprise at least vitamin E, and
at least one matrix material,
and wherein the edible particles of the second variety comprise from 0.1 weight-% to 20 weight-% vitamin E, based on the total weight of the edible particles of the first variety.

11. A method of manufacturing of a kit comprising single-serving packs, comprising the step of filling edible particles of two or more varieties into at least two single-serving packs, wherein
edible particles of a first variety comprise at least three active ingredients,
and
edible particles of a second variety comprise at least one active ingredient,
wherein
the edible particles of said second variety comprise fewer active ingredients than the edible particles of said first variety, and
and wherein the edible particles of the first variety and the edible particles of the second variety comprise at least one common active ingredient, said at least one common active ingredient being an active ingredient that is comprised in said first and in said second variety of edible particles.

12. A kit obtained by the method of claim 11, comprising at least two single-serving packs each comprising a mixture of the edible particles of the first variety and the edible particles of the second variety.

13. (canceled)

14. (canceled)

15. (canceled)

16. The composition according to claim 1, wherein the composition has one common active ingredient only.

17. The composition according to claim 1, wherein the composition has one common active ingredient only and wherein the edible particles of the second variety comprise no active ingredient other than the at least one common active ingredient.

18. The composition according to claim 1, wherein the weight ratio between the edible particles of the first variety and the edible particles of the second variety is from 10:1 to 3:1 and wherein the composition comprises at least 25 mg of the edible particles of the second variety.

19. The composition according to claim 1, wherein the composition comprises at least 50%-weight granules, based on the total weight of the composition, and wherein said granules are agglomerated spray dried particles.

20. The composition according to claim 1, wherein said at least one common active is selected from the group consisting of minerals, water soluble vitamins, and fat soluble vitamins.

21. The composition according to claim 1, wherein at the edible particles of the first variety comprise at least two minerals selected from the group consisting of sources of calcium ions, sources of magnesium ions, sources of zinc ions, sources of iodine, sources of selenium ions, sources of chromium ions, sources of copper ions, sources of iron ions, sources of manganese ions, sources of molybdenum ions, sources of potassium ions and sources of phosphorus ions.

22. A method of personalizing a dietary supplement or nutraceutical supplement comprising the steps of:
a. identifying the dietary needs of two or more individual or groups of consumers; and
b. administering to a first individual or group, respectively, a first dose; and
c. administering to a second individual or group, respectively, a second dose;
wherein the first dose and second dose each comprise a composition comprising a plurality of edible particles of two or more varieties, wherein edible particles of a first variety comprise at least three active ingredients, and edible particles of a second variety comprise at least one active ingredient, wherein the edible particles of the second variety comprise fewer active ingredients than the edible particles of the first variety, and wherein the edible particles of the first variety and the edible particles of the second variety comprise at least one common active ingredient, said at least one common active ingredient being an active ingredient that is comprised in said first and in said second variety of edible particles, and
wherein the first dose differs from the second dose in the amount of the first variety of edible particles or the amount of the second variety of edible particles.
